(19) United States
(12) Patent Application Publication
(10) Pub. No.: US 2025/0199249 A1
(43) Pub. Date: Jun. 19, 2025

(54) STACKED MULTI-CHANNEL LC OPTICAL FIBER MODULE

(71) Applicant: Xiao ZHANG, Guangdong (CN)

(72) Inventor: Xiao ZHANG, Guangdong (CN)

(21) Appl. No.: 18/540,899

(22) Filed: Dec. 15, 2023

(51) Int. Cl. G02B 6/38

(52) U.S. Cl. CPC G02B 6/3885; G02B 6/3825

(57) ABSTRACT

The utility model relates to a stacked multi-channel LC optical fiber module, including multiple adapter units and a fixing member. A first connecting portion and a second connecting portion are disposed on a lower surface of the adapter unit in a protruding manner, and a third connecting portion and a fourth connecting portion are provided on an upper surface of the adapter unit in a protruding manner. When two of the adapter units are stacked vertically, the upper first connecting portion and the lower third connecting portion are connected to provide a first fixing position, and the upper second connecting portion and the lower fourth connecting portion are connected to provide a second fixing position. In addition, the fitting between the first fixing position and the second fixing position enables the two stacked adapter units to be parallel with a gap therebetween.

### TECHNICAL FIELD

The utility model relates to the field of fiber optic adapters, and in particular to a stacked multi-channel LC optical fiber module.

### BACKGROUND OF THE INVENTION

An LC fiber optic adapter is a common adapter device during fiber optic transmission and provided with a plug slot into which a connector is plugged. When the connector is plugged into the fiber optic adapter, the LC fiber optic adapter is connected to the optical fiber line of the connector. The common LC fiber optic adapters are classified in to simplex adapters and duplex adapters in terms of specification. The simplex adapter has one channel, while the duplex adapter has two channels. More channels indicate a higher efficiency of fiber optic transmission. To further increase the efficiency of fiber optic transmission, multiple LC fiber optic adapter units are always integrated into a single device, such as a four-core LC fiber optic adapter, which is provided with four channels in a housing, with reference to Patent Application No.CN201420195036.5; and an eight-core LC fiber optic adapter, with reference to Patent Application No.CN201420099687.4.

It can be seen that the multiple adapter units are horizontally arranged together in the conventional multi-channel LC fiber optic adapter device, resulting in a large footprint for the multi-channel LC fiber optic adapter device. Therefore, it has been proposed that the adapter units are arranged vertically. That is, the multiple adapter units are stacked and then fixed using a fixing member.

However, when the adapter units of the conventional structure are stacked vertically, upper and lower adapter units are likely to slide. As a result, the fiber optic adapter formed cumulatively is quite likely to be loose and fall apart. In addition, after multiple connectors are correspondingly plugged into the adapter unit, in two upper and lower adjacent connectors, the upper connector interferes with the pressing portion of the lower connector. As a result, after the lower connector is plugged into the fiber optic adapter, its pressing portion is squeezed and cannot be connected stably.

### BRIEF SUMMARY OF THE INVENTION

To resolve the problems that the conventional LC fiber optic adapter units are loose after stacked, and interference between connectors on two upper and lower adjacent adapter units leads to loose connection between the connector and the adapter, the utility model provides a stacked multi-channel LC optical fiber module.

A technical solution of the utility model is described as follows:

A stacked multi-channel LC optical fiber module is provided, including multiple adapter units and a fixing member configured to fix the multiple adapter units stacked together. A first connecting portion and a second connecting portion are disposed on a lower surface of the adapter unit in a protruding manner, and a third connecting portion and a fourth connecting portion are provided on an upper surface of the adapter unit in a protruding manner. When two of the adapter units are stacked vertically, the first connecting portion of the upper adapter unit and the third connecting portion of the lower adapter unit are connected to provide a first fixing position, so as to limit the two adapter units in a first direction and a second direction; and the second connecting portion of the upper adapter unit and the fourth connecting portion of the lower adapter unit are connected to provide a second fixing position to fit with the first fixing portion, such that the two stacked adapter units are parallel with a gap there between.

The utility model according to the foregoing solution has the following beneficial effects:

In the utility model, the first connecting portion and the second connecting portion are disposed on the lower surface of the adapter unit, and the third connecting portion and the fourth connecting portion are provided on the upper surface of the adapter unit. When two adapter units are stacked vertically, the first connecting portion of the upper adapter unit and the third connecting portion of the lower adapter unit are connected to provide the first fixing position, so as to limit the two adapter units in the first direction and the second direction. The second connecting portion of the upper adapter unit and the fourth connecting portion of the lower adapter unit are connected to provide the second fixing position. The second fixing position fits with the first fixing position, so as to form a stable connection surface.

In addition, because of the first fixing position and the second fixing position, the gap is present between the lower surface of the adapter unit and the upper surface of the lower adapter unit, so as to distance the upper connector from the lower connector, such that the upper connector does not interfere with the top of the pressing portion of the lower connector, ensuring that the pressing portion of the lower connector is not squeezed, thus achieving the stable connection between the lower connector and the lower adapter unit.

### BRIEF DESCRIPTION OF THE DRAWINGS

FIG. 1 is a schematic structural diagram of an optical fiber module according to the utility model.

FIG. 2 is a schematic structural diagram of the optical fiber module from another perspective.

FIG. 3 is a schematic structural diagram of a module plate according to the utility model.

FIG. 4 is a schematic structural diagram of an adapter unit from a bottom perspective according to the utility model.

FIG. 5 is a schematic structural diagram of the adapter unit from a top perspective.

FIG. 6 is a schematic structural diagram of the adapter unit from another perspective.

FIG. 7 is an exploded structural diagram of the adapter unit.

FIG. 8 is a schematic structural diagram of a connector.

FIG. 9 is a schematic diagram of the connector and the adapter unit being combined.

FIG. 10 is a cross-sectional diagram of the connector and the adapter unit being combined.

FIG. 11 is a schematic diagram of a single-channel adapter unit according to another optional embodiment.

FIG. 12 is a schematic diagram of a four-channel adapter unit according to another optional embodiment.

In the accompanying drawings:
1. adapter unit; 11. first connecting portion; 111. first limit portion; 112. second limit portion; 12. second connecting portion; 13. third connecting portion; 14. fourth connecting portion; 15. side-tab connecting portion; 16. first elastic piece; 17. second elastic piece; 18. plug slot;
2. inner anti-dust cover; 21. rotation shaft; 22. block surface; and 23. torsion spring;
3. module plate; 31. mounting hole;
4. connector; 41. pressing portion; 42. pressed portion; and 43. clamping block.

### DETAILED DESCRIPTION OF THE INVENTION

To better understand the purpose, technical solution, and technical effects of the utility model, the following further describes the utility model with reference to the accompanying drawings and embodiments. It should be noted that similar numerals and letters in the subsequent drawings represent similar items. Therefore, an item, once defined in one figure, does not need to be defined and explained in the subsequent figures. In addition, the following embodiments are used to merely explain the utility model instead of limiting the utility model.

It should be noted that, the terms “first” and “second” are for descriptive purposes only and are not to be construed as indicating or implying their relative importance or implicitly specifying the number of indicated technical features. “A plurality of” means two or more, unless otherwise specifically defined.

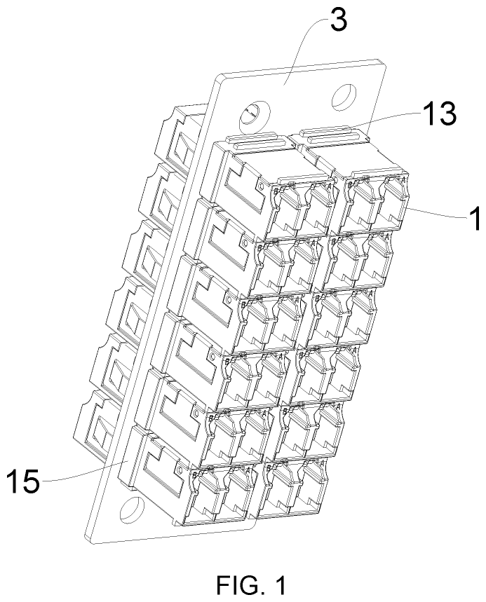

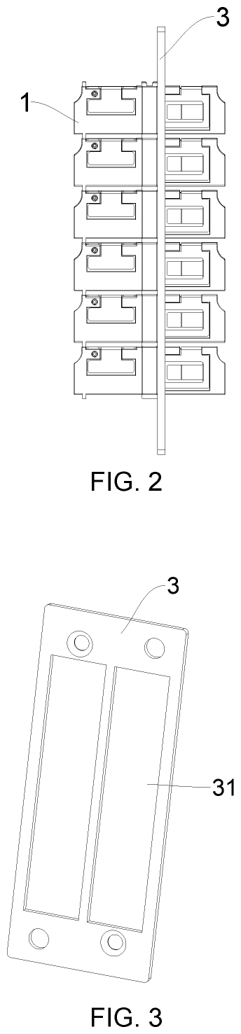

As shown in FIGS. 1 to 5, a stacked multi-channel LC optical fiber module is provided, including multiple adapter units 1 and a fixing member configured to fix the multiple adapter units 1 stacked together. In an optional embodiment, the fixing member is a module plate 3 provided with mounting holes 31, such as a module plate 3 with two mounting holes 31, the mounting hole 31 being rectangular. Each mounting hole 31 may be used for mounting various stacked adapter units 1 so as to assemble them into two columns of multi-channel LC optical fiber modules. In another optional embodiment, if the module plate 3 has three mounting holes 31, three columns of multi-channel LC optical fiber modules are assembled.

A duplex adapter is used as the adapter unit 1 in this embodiment. To be specific, one adapter unit 1 has two channels. When six duplex adapters are mounted in one mounting hole 31, a 24-channel LC optical fiber module can be assembled using the module plate 3 with two mounting holes 31. It can be seen that the height of mounting hole 31 in the module plate 3 is an integral multiple of the height of adapter unit 1.

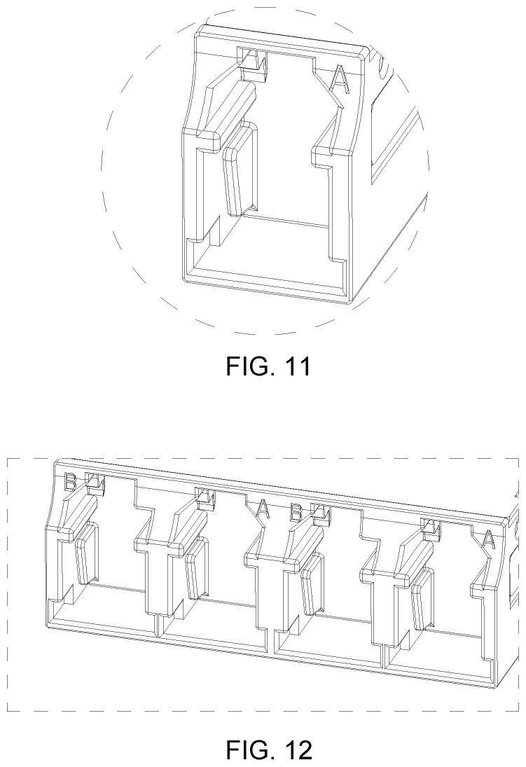

In another optional embodiment, the adapter unit may alternatively be a single-channel adapter, so as to assemble a small LC optical fiber module with reference to FIG. 11. The adapter unit may alternatively be a four-channel adapter to assemble an LC optical fiber module meeting more channel requirements with reference to FIG. 12.

The utility model is assembled in the following manner: A proper number of adapter units 1 are aligned vertically and stacked, and then enabled to run into one mounting hole 31 of the module plate 3.

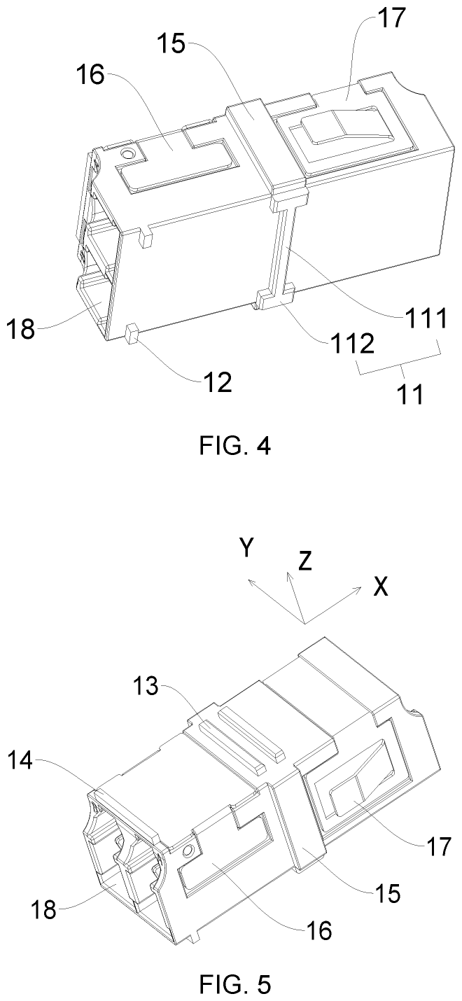

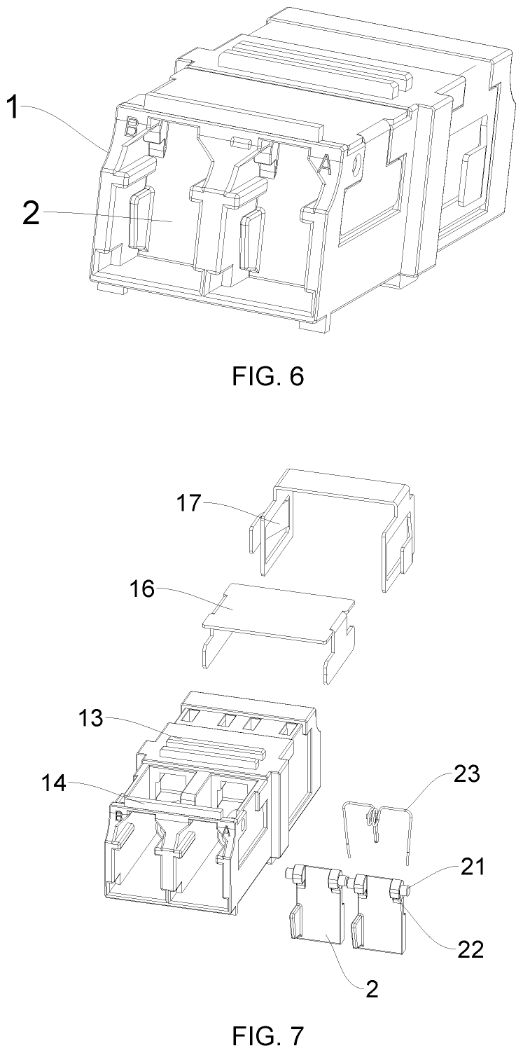

As shown in FIGS. 4 and 5, in the utility model, a first connecting portion 11 and a second connecting portion 12 are disposed on a lower surface of the adapter unit 1 in a protruding manner, and a third connecting portion 13 and a fourth connecting portion 14 are provided on an upper surface of the adapter unit in a protruding manner. When two of the adapter units 1 are stacked vertically, the first connecting portion 11 of the upper adapter unit 1 and the third connecting portion 13 of the lower adapter unit 1 are connected to provide a first fixing position, so as to limit the two adapter units 1 in a first direction and a second direction. As shown in FIG. 5, the first direction is the direction X in the figure, and the second direction is the direction Y in the figure. The second connecting portion 12 of the upper adapter unit 1 and the fourth connecting portion 14 of the lower adapter unit 1 are connected to provide the second fixing position. The second fixing position fits with the first fixing position, so as to form a stable connection surface. The two adapter units 1 do not swing in the direction Z, such that an upper surface and a lower surface of two stacked adapter units 1 are parallel. That is, the lower surface of the upper adapter unit 1 is parallel to and stably connected to the upper surface of the lower adapter unit 1.

In addition, because of the first fixing position and the second fixing position, a gap is present between the lower surface of the upper adapter unit 1 and the upper surface of the lower adapter unit 1. In this way, an upper connector 4 plugged into the upper adapter unit 1 is distanced from the lower connector 4 plugged into the lower adapter unit 1, such that the upper connector 4 does not interfere with the top of the pressing portion 41 of the lower connector 4, ensuring that the pressing portion 41 of the lower connector 4 is not squeezed, thus achieving the stable connection between the lower connector 4 and the lower adapter unit 1.

In summary, according to the stacked multi-channel LC optical fiber module of the utility model, the first connecting portion 11 and the second connecting portion 12 are disposed on the upper surface of the housing of adapter unit 1, and the third connecting portion 13 and the fourth connecting portion 14 are disposed on the lower surface of the housing of the adapter unit 1. The first connecting portion 11 of the upper adapter unit 1 is connected to the third connecting portion 13 of the lower adapter unit 1, to provide the first fixing position, and the second connecting portion 12 of the upper adapter unit 1 is connected to the fourth connecting portion 14 of the lower adapter unit 1, to provide the second fixing position, so as to connect two upper and lower adjacent adapter units 1 in a limited manner. Based on such combination structure, multiple adapter units 1 can be stacked and assembled vertically. In addition, connectors 4 on two adjacent adapter units 1 can be distanced from each other using the first fixing position and the second fixing position, such that the upper connector 4 does not interfere with the pressing portion 41 of the lower connector 4, improving the stability of plugging the lower connector 4 into the adapter unit 1.

In a specific embodiment, the first connecting portion 11 and the third connecting portion 13 are disposed in the middle of the adapter unit 1, and the second connecting portion 12 and the fourth connecting portion 14 are disposed at one end of the adapter unit 1 close to a plug slot 18. The first fixing position is arranged in the middle of the adapter unit 1, and the second fixing position is arranged at one end of the adapter unit 1 close to the plug slot 18, ensuring higher stability between the adapter units 1 at one end of the plug slot 18. The connector 4 at one end of the plug slot 18 brings some disturbance, and therefore high stability of this end is required.

Specifically, the first connecting portion 11 is a dumbbell-shaped protruding block, the third connecting portion 13 is a pair of first protruding bars parallel to each other, and the pair of first protruding bars are adaptively joined with the dumbbell-shaped protruding block. The dumbbell-shaped protruding block includes a first limit portion 111 in the middle and second limit portions 112 at two ends. After the dumbbell-shaped protruding block is joined with the first protruding bars, the first limit portion 111 is inserted between the two first protruding bars, and therefore the first limit portion 111 is limited by the first protruding bars on two sides, thus limiting displacement of the two adapter units 1 in the first direction. Because the outer side surface of the first protruding bar abuts against the inner side surface of the second limit portion 112, the first protruding bar is limited by second limit portions 112 at two ends, thus limiting the displacement of the two adapter units 1 in the second direction.

In an optional embodiment, the outer side surfaces of the second limit portions 112 at two ends of the dumbbell-shaped protruding block are flush with the side surface of the adapter unit 1.

In an optional embodiment, the first limit portion 111 and the first protruding bar are both parallel to a short edge of the adapter unit 1, the first direction is perpendicular to a direction of the short edge, that is, the direction X in the figure, and the second direction is parallel to the direction of the short edge, that is, the direction Y in the figure. The first direction being perpendicular to the second direction can limit two upper and lower adjacent adapter units 1 to the greatest extent, improving the connection stability on a plane XY. The multiple adapter units 1 stacked vertically are placed in the mounting hole 31 of the module plate 3, and under the fixing of the module plate 3 along the stacking direction (that is, the direction Z) of the adapter unit 1, the structure of the LC optical fiber module is firm.

In the utility model, the second connecting portion 12 is a pair of rectangular protruding blocks that are respectively located on left and right sides of the lower surface of the adapter unit, the fourth connecting portion 14 is a second protruding bar, and the second protruding bar is inserted between the two rectangular protruding blocks, preventing displacement of the adapter unit 1 on a side of the plug slot 18 along the second direction, thus improving the stability of the adapter unit 1 on this side. In an optional embodiment, the widths of the rectangular protruding block and the second protruding bar are equal, such that the second connecting portion 12 and the fourth connecting portion 14 are connected to form a flat straight line.

In the utility model, a plug slot 18 into which a connector 4 is plugged is provided on a front side of the adapter unit 1, and side-tab connecting portions 15 protruding from side surfaces of the adapter unit 1 are disposed on left and right sides of the adapter unit. A side surface of the side-tab connecting portion 15 close to the second elastic piece 17 abuts against a plate surface of the module plate 3. In an optional embodiment, the widths of the side-tab connecting portion 15 and the second limit portion 112 of the first connecting portion 11 are equal, preventing the second limit portion 112 from interfering with the connection between the side-tab connecting portion 15 and the module plate 3.

After the adapter unit 1 is mounted in the mounting hole 31 of the module plate 3, the side edge of the mounting hole 31 is clamped in the gap between the side-tab connecting portion 15 of the adapter unit 1 and the second elastic piece 17, the side surface of the side-tab connecting portion 15 abuts against the plate surface on a side of the mounting hole 31, the side surface of the second protruding bar on the upper surface of the uppermost adapter unit 1 abuts against the place surface at a top edge of the mounting hole 31, and the side surface of the second limit portion 112 on the lower surface of the lowest adapter unit 1 abuts against the plate surface at a bottom edge of the mounting hole 31.

As shown in FIG. 7, in the utility model, the adapter unit 1 includes a first elastic piece 16 and a second elastic piece 17. The first elastic piece 16 and the second elastic piece 17 are both buckled with the housing of the adapter unit 1. Specifically, the first elastic piece 16 is buckled at one end of the housing close to the plug slot 18, and the second elastic piece 17 is buckled at the other end of the housing. The side wings of the second elastic piece 17 arch outward. In the process of plugging the adapter unit 1 into the mounting hole 31 of the module plate 3, the side wings at two sides of the second elastic piece 17 are squeezed and pulled inward. After the module plate 3 is clamped in the gap between the side-tab connecting portion 15 and the second elastic piece 17, the second elastic piece 17 is sprung back and reset, and the adapter unit 1 is plugged in position.

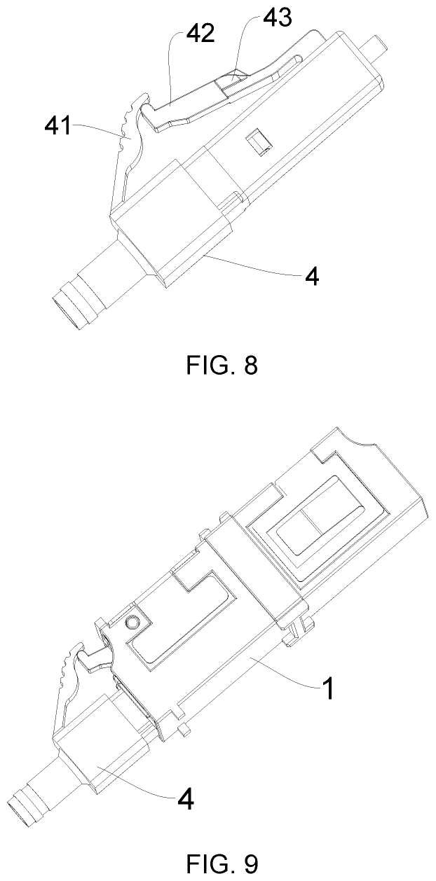

As shown in FIG. 8, in an optional embodiment, the connector 4 is of a conventional structure. Specifically, the connector is provided with a pressing portion 41 and a pressed portion 42 that are elastic, where the front end of the pressing portion 41 is in contact with an end of the pressed portion 42. When the pressing portion 41 is pressed, the pressed portion 42 is squeezed and deformed, so as to unlock the connector 4 and the adapter unit 1 and unplug the connector 4 from the plug slot 18 of the adapter unit 1.

As shown in FIGS. 7 and 9, in the utility model, an inner anti-dust covers 2 is provided in the plug slot 18 of the adapter unit 1, a protruding rotation shaft 21 is provided at an end of the inner anti-dust cover 2, and the inner anti-dust cover 2 is rotatably connected into a housing of the adapter unit 1 via the rotation shaft 21. When the connector 4 is plugged, it can push open the inner anti-dust cover 2 and allow it to rotate, such that the connector 4 can be plugged into the plug slot 18. A torsion spring 23 or another rotational power spring is provided at the rotation shaft 21 of the inner anti-dust cover 2. When the connector 4 is plugged into the plug slot 18 to push open the inner anti-dust cover 2, the torsion spring 23 is deformed and generates a reset elastic force. When the connector 4 is unplugged from the plug slot 18, the inner anti-dust covers 2 is automatically reset under the elastic force.

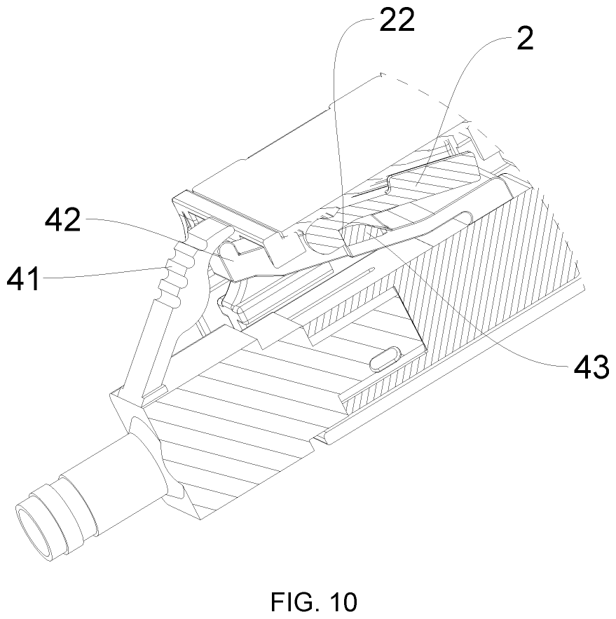

As shown in FIG. 10, a block surface 22 is provided on a side of the rotation shaft 21 of the inner anti-dust cover 2, and a clamping block 43 is provided on a side surface of the pressed portion 42 of the connector 4 in a protruding manner. After the connector 4 is plugged in position, the block surface 22 of the inner anti-dust cover 2 that has been turned over abuts against the clamping block 43 of the connector 4, thus allowing for stable connection between the connector 4 and the adapter unit 1. When the lower connector 4 needs to be removed, the pressing portion 41 is pressed downward to make the pressed portion 42 deform downward. The clamping block 43 on the pressed portion 42 is accordingly moved downward and separated from the block surface 22, and the connector 4 is released and can be smoothly unplugged from the plug slot 18.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

The above embodiments are only intended to illustrate several implementations of the utility model in detail, and they should not be construed as a limitation to the patentable scope of the utility model. It should be noted that those of ordinary skill in the art may further make several modifications and improvements without departing from the concept of the utility model, and these modifications and improvements also fall within the protection scope of the utility model. Therefore, the protection scope of the utility model should be subject to the protection scope defined by the claims.

What is claimed is:

1. A stacked multi-channel LC optical fiber module, comprising multiple adapter units and a fixing member configured to fix the multiple adapter units stacked together, wherein
a first connecting portion and a second connecting portion are disposed on a lower surface of the adapter unit in a protruding manner, and a third connecting portion and a fourth connecting portion are provided on an upper surface of the adapter unit in a protruding manner, wherein when two of the adapter units are stacked vertically, the first connecting portion of the upper adapter unit and the third connecting portion of the lower adapter unit are connected to provide a first fixing position, so as to limit the two adapter units in a first direction and a second direction; and
the second connecting portion of the upper adapter unit and the fourth connecting portion of the lower adapter unit are connected to provide a second fixing position to fit with the first fixing position, such that the two stacked adapter units are parallel with a gap therebetween.

2. The stacked multi-channel LC optical fiber module according to claim 1, wherein the first connecting portion and the third connecting portion are disposed in the middle of the adapter unit, and the second connecting portion and the fourth connecting portion are disposed at one end of the adapter unit close to a plug slot.

3. The stacked multi-channel LC optical fiber module according to claim 1, wherein the first connecting portion is a dumbbell-shaped protruding block, the third connecting portion is a pair of first protruding bars parallel to each other, and the pair of first protruding bars are adaptively joined with the dumbbell-shaped protruding block.

4. The stacked multi-channel LC optical fiber module according to claim 3, wherein the dumbbell-shaped protruding block comprises a first limit portion in the middle and second limit portions at two ends, and after the dumbbell-shaped protruding block is joined with the first protruding bars, the first limit portion is inserted between the two first protruding bars to limit displacement of the two adapter units in the first direction; and outer side surfaces of the two first protruding bars abut against inner side surfaces of the second limit portions to limit displacement of the two adapter units in the second direction.

5. The stacked multi-channel LC optical fiber module according to claim 4, wherein the first limit portion and the first protruding bar are both parallel to a short edge of the adapter unit, the first direction is perpendicular to a direction of the short edge, and the second direction is parallel to the direction of the short edge.

6. The stacked multi-channel LC optical fiber module according to claim 1, wherein the second connecting portion is a pair of rectangular protruding blocks, the fourth connecting portion is a second protruding bar, and the second protruding bar is inserted between the two rectangular protruding blocks.

7. The stacked multi-channel LC optical fiber module according to claim 1, wherein an inner anti-dust cover is provided in the plug slot of the adapter unit, a protruding rotation shaft is provided at an end of the inner anti-dust cover, and the inner anti-dust cover is rotatably connected into a housing of the adapter unit via the rotation shaft.

8. The stacked multi-channel LC optical fiber module according to claim 7, wherein a side surface of the rotation shaft of the inner anti-dust cover is used as a block surface, and the block surface is configured for abutting against a clamping block protruding from a side surface of a pressed portion of a connector.

9. The stacked multi-channel LC optical fiber module according to claim 1, wherein a plug slot into which a connector is plugged is provided on a front side of the adapter unit, and side-tab connecting portions protruding from side surfaces of the adapter unit are disposed on left and right sides of the adapter unit.

10. The stacked multi-channel LC optical fiber module according to claim 1, wherein the fixing member is a module plate with a mounting hole, and a side edge of the mounting hole is clamped in a gap between the side-tab connecting portion of the adapter unit and a second elastic piece.
